(19) United States
(12) Patent Application Publication
(10) Pub. No.: US 2016/0218931 A1
(43) Pub. Date: Jul. 28, 2016

(54) SYSTEM FOR DETERMINING INTER-ELEMENT INFLUENCE, DEVICE FOR DETERMINING INTER-ELEMENT INFLUENCE, METHOD FOR DETERMINING INTER-ELEMENT INFLUENCE, AND RECORDING MEDIUM

(71) Applicant: NEC CORPORATION, Tokyo (JP)

(72) Inventors: Satoko ITAYA, Tokyo (JP); Naoki YOSHINAGA, Tokyo (JP); Rie TANAKA, Tokyo (JP); Taku KONISHI, Tokyo (JP); Shinichi DOI, Tokyo (JP); Peter DAVIS, Kyoto (JP)

(73) Assignee: NEC Corporation, Tokyo (JP)

(21) Appl. No.: 15/025,850

(22) PCT Filed: Sep. 29, 2014
(86) PCT No.: PCT/JP2014/075860

§ 371 Date: Mar. 29, 2016

(30) Foreign Application Priority Data
Sep. 30, 2013 (JP) 2013-205306

(51) Int. Cl. H04L 12/24; H04L 29/08

(52) U.S. Cl. CPC H04L 41/12; H04L 67/32

(57) ABSTRACT

In the inter-element influence determination apparatus, a receiver receives request information from a user terminal. A system information storage device stores system information containing attribute information indicating attributes of each element in a system. A relationship information storage device stores relationship information indicating relationships in which direct interaction is provided between elements. On the basis of the attribute information and the relationship information, an influence determiner virtually connects each element included in the system, thereby creating a system network model which models the system, and on the basis of the system network model, determines whether a second element is influenced when a change is made to a first element. A transmitter transmits to the user terminal determination result information indicating the result of the determination by the influence determiner.

### TECHNICAL FIELD

The present disclosure relates to a system for determining inter-element influence, a device for determining inter-element influence, a method for determining inter-element influence and a recording medium.

### BACKGROUND ART

In various fields, multiple partial systems with different functions are interconnected and mutually influence each other, while operating as a single system. In this kind of system, in order to evaluate whether or not making a change to a part causes another part to be influenced, it is necessary to conduct a system evaluation that takes into consideration what kind of influence another partial system has on the partial system being evaluated.

For example, in urban planning there is known to be a close relationship between afforestation plans, road plans and biodiversity maintenance plans. When these systems are considered independently and optimized, there are times when great damage is done to one of the systems. For example, in Australia, it is prohibited to cut down trees and put in asphalt roads that divide the habitat area of the koala, which is a nationally protected animal. This is because the entire system that is a city comprises models of multiple partial systems that are connected and mutually influence each other, such as a road network, a koala ecosystem, human life and so forth, and dividing a koala migration area by building new roads is known to damage the koala ecosystem.

In addition, for example when a road with no direct relationship to the production activities or distribution routes of company X and situated at a location separated by several hundred kilometers is severed, because the road was used in shipping from company Z which supplies components for making a part that company Y produces and that is used by company X when producing product A, development of product A stagnates. Such problems are actualized as a result of such events as the Great East Japan Earthquake, tunnel collapses and/or the like. This illustrates that the entire system for producing product A comprises multiple partial systems such as the road network, the parts' component shipping network, the component procurement network and/or the like that are connected and mutually influence each other, and that the malfunctioning of the parts' component shipping network at times has an influence on product production itself. As in these examples, problems that at first glance appear to have no relationship at times exert a profound influence in unexpected places.

In this manner, when the entire system comprises multiple different partial systems, if policies are not determined after evaluating the influences among the different partial systems, cases could arise in which a partial system being destroyed or an element of a partial system changing causes large problems for the entire system.

However, in order to evaluate the influence among the different partial systems, it is necessary to recognize all partial systems comprising the entire system, connect models of these partial systems to comprise the entire system and understand how an element of a given partial system influences elements of another partial system, and to forecast problems that could occur in the future and specify the causes by observing changes in elements of a given partial system.

Examples of system evaluations that take into consideration this kind of influence among different systems are disclosed in Patent Literature 1, Patent Literature 2, Patent Literature 3 and Patent Literature 4.

In Patent Literature 1, a system is proposed that prepares and makes visible information such as processes dependent on a company's business elements, the type of business and related departments, process means and/or the like. In this system, at places where monitoring is necessary, data is collected and compared to a desirable value (industry average and/or the like) with the objective of making management easier.

In Patent Literature 2, a system for forecasting the influence urban afforestation will have on improving biodiversity is proposed.

In Patent Literature 3, a system for extracting changes in transaction conditions based on relevant transaction history, swiftly accomplishing risk reconsideration and creating evaluation reports to do credit management is proposed.

In Patent Literature 4, a device for combining data among different types of databases that automatically accomplish aggregation of similar information, that is to say data of the same meaning, from two databases using different categories of attributes as a key is disclosed.

### CITATION LIST

### Patent Literature

Patent Literature 1: Unexamined Japanese Patent Application Kokai Publication No. 2006-048145.

Patent Literature 2: Unexamined Japanese Patent Application Kokai Publication No. 2009-136265.

Patent Literature 3: National Patent Publication No. 2012-522291.

Patent Literature 4: Unexamined Japanese Patent Application Kokai Publication No. H05-127959.

### SUMMARY OF INVENTION

### Technical Problem

However, in the above-described art, it is impossible to evaluate, at low cost, the absence or presence of an influence among elements with no relationship providing direct interaction, as indicated below.

The system proposed in Patent Literature 1 can make information inside a closed system visible. However, in order to evaluate the influence on the entire system extending over multiple partial systems, a user needs to study the relationship among the elements extending over the multiple partial systems, and correctly reflect this in the system. It is difficult for a user to evaluate what influence an element existing in a given partial system has on another element existing in another partial system. In particular, when there is no relationship providing direct interaction between a given element and another element, the user's evaluation of the influence between these elements becomes an enormous burden to the user in terms of time and cost.

In the system proposed in Patent Literature 2, the influence from outside the system is indicated completely by macrovariables. Because the relationship between each element and the macrovariables was unclear, it was impossible to clarify specifically what kinds of changes arising in which elements have an influence on which elements of the system. Consequently, when a change was made to elements within the system, it was impossible to accurately evaluate what kind of influence this had on other elements.

In the system proposed in Patent Literature 3, a transaction database is monitored and changes in transaction status are extracted. However, because an evaluation based on the relationships among the elements is not done, when there was a change in a transaction, it is impossible to clarify on what change in which elements that was based and what influence this has on which elements. Consequently, when a change was made to an element within the system, it was impossible to evaluate whether or not this had an influence on other elements with which there is no relationship providing direct interaction.

In Patent Literature 4, a data-combining device is disclosed for combining data from databases in which unified names of categories that are keys match. However, this data-combining device only combines data of databases based on unified names, so when a change was made to a given element, it was impossible to evaluate whether or not this had an influence on other elements with which there is no relationship providing direct interaction.

In consideration of the foregoing, it is an objective of the present disclosure to determine at low cost the absence or presence of an influence among elements having no relationship providing direct interaction.

### Solution to Problem

An inter-element influence determination system according to a first aspect of the present disclosure is an inter-element influence determination system comprising a user terminal and an inter-element influence determination apparatus connected by a network, wherein:

the user terminal comprises:

an input device that acquires request information indicating a first element included in a system and a second element that is a target for determining whether or not an influence is felt when changes are made to the first element, based on user input, and transmits the request information to the inter-element influence determination apparatus; and

an output device that outputs information received from the inter-element influence determination apparatus to a user; and

the inter-element influence determination apparatus comprises:

a receiver that receives the request information from the user terminal;

a system information storage device that stores system information including attribute information indicating attributes of various elements of the system;

a relationship information storage device that stores relationship information indicating relationships providing direct interaction among the elements in the system;

an influence determiner that creates a system network model that models the system by virtually connecting the various elements included in the system on the basis of the system information and the relationship information, and determines whether or not an influence is felt by the second element indicated by the received request information when changes are made to the first element indicated by the received request information, based on the system network model created; and

a transmitter that transmits to the user terminal determination result information indicating results determined by the influence determiner.

An inter-element influence determination apparatus according to a second aspect of the present disclosure comprises:

an acquirer that acquires request information indicating a first element included in a system, and a second element that is a target of determining whether or not an influence is felt when a change is made to the first element, based on user input;

a system information storage device that stores system information including attribute information indicating attributes of various elements of the system;

a relationship information storage device that stores relationship information indicating relationships providing direct interaction among the elements, in the system; and

an influence determiner that creates a system network model that models the system by virtually connecting the various elements included in the system on the basis of the system information and the relationship information, and determines whether or not an influence is felt by the second element indicated by the received request information when changes are made to the first element indicated by the received request information, based on the system network model created.

An inter-element influence determination method according to a third aspect of the present disclosure includes:

an acquisition step that acquires request information indicating a first element included in a system, and a second element that is a target of determining whether or not an influence is felt when a change is made to the first element, based on user input;

a creation step that creates a system network model that models the system by virtually connecting the various elements included in a system on the basis of system information including attribute information indicating attributes of various elements of the system and relationship information indicating relationships providing direct interaction among elements, in the system; and

an influence determination step that determines whether or not an influence is felt by the second element indicated by the acquired request information when changes are made to the first element indicated by the acquired request information, based on the system network model created in the creation step.

A recording medium according to a fourth aspect of the present disclosure has recorded thereon a program that causes a computer to function as:

acquisition means that acquires request information indicating a first element included in a system, and a second element that is a target of determining whether or not an influence is felt when a change is made to the first element, based on user input;

creation means that creates a system network model that models the system by virtually connecting the various elements included in a system on the basis of system information including attribute information indicating attributes of various elements of the system and relationship information indicating relationships providing direct interaction among elements, in the system; and

influence determination means that determines whether or not an influence is felt by the second element indicated by the acquired request information when changes are made to the first element indicated by the acquired request information, based on the system network model created by the creation means.

### Advantageous Effects of Invention

With the present disclosure, it is possible to determine at low cost the absence or presence of an influence among elements having no relationship providing direct interaction.

### BRIEF DESCRIPTION OF DRAWINGS

FIG. 1 is a block diagram showing an exemplary configuration of an inter-element influence determination system according to a first exemplary embodiment of the present disclosure;

FIG. 2 is a flowchart showing one example of the actions of an inter-element influence determination process according to the first exemplary embodiment;

FIG. 3 is a diagram showing one example of system information according to the first exemplary embodiment;

FIG. 4 is a schematic diagram showing one example of a network model for a purchasing system according to the first exemplary embodiment;

FIG. 5 is a schematic diagram showing one example of a system network model according to the first exemplary embodiment;

FIG. 6 is a drawing showing one example of event information according to the first exemplary embodiment;

FIG. 7 is a schematic diagram showing one example of a system network model taking events into consideration, according to the first exemplary embodiment;

FIG. 8 is a flowchart showing one example of the actions of an influence determination process according to the first exemplary embodiment;

FIG. 9 is a flowchart showing one example of the actions of an influence determination process according to the first exemplary embodiment;

FIG. 10 is a schematic diagram showing one example of an influence determination process in a system network model according to the first exemplary embodiment;

FIG. 11 is a schematic diagram showing one example of an influence determination process in a system network model according to the first exemplary embodiment;

FIG. 12 is a block diagram showing an exemplary configuration of an inter-element influence determination system according to a second exemplary embodiment of the present disclosure;

FIG. 13 is a flowchart showing one example of the actions of an influence determination process according to the second exemplary embodiment; and

FIG. 14 is a block diagram showing one example of a hardware configuration of an inter-element influence determination apparatus according to the exemplary embodiments of the present disclosure.

### DESCRIPTION OF EMBODIMENTS

Below, exemplary embodiments of the present disclosure are described in detail with reference to the drawings. The same or corresponding components in the drawings are labeled with the same reference signs. In the below exemplary embodiment, the system comprises elements that supply and/or are supplied with materials and/or services.

### First Exemplary Embodiment

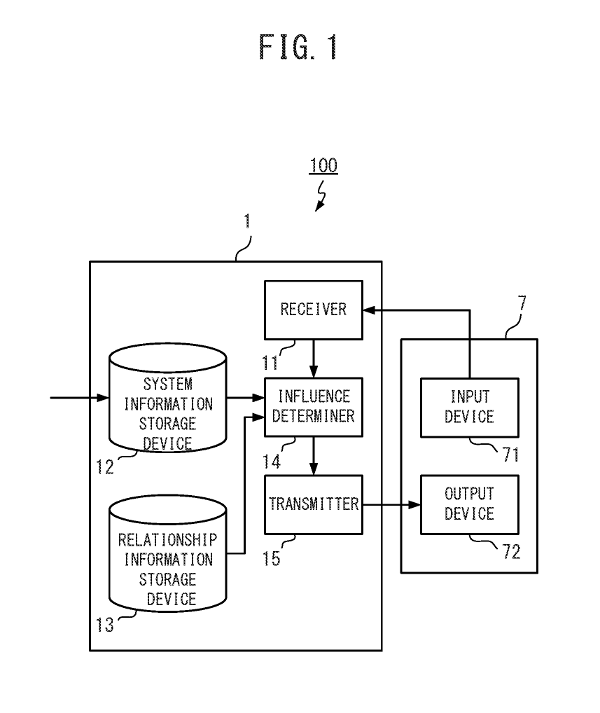

FIG. 1 is a block diagram showing an exemplary configuration of an inter-element influence determination system according to a first exemplary embodiment of the present disclosure. An inter-element influence determination system 100 according to the first exemplary embodiment comprises an inter-element influence determination apparatus 1 and a user terminal 7. The inter-element influence determination apparatus 1 and the user terminal 7 are capable of communicating with each other via a network.

The user terminal 7 is illustrated as one unit as an example, but in some cases multiple user terminals 7 could be connected to a network. In addition, the user terminal 7 in some cases is a part of the inter-element influence determination apparatus 1 or is a device attached thereto.

The user terminal 7 comprises an input device 71 with which a user inputs request information indicating a system, and elements thereof, for which the user is requesting a determination of the possibility of influence, and an output device 72 for outputting information received from the inter-element influence determination apparatus 1. The user inputs into the user terminal 7, via the input device 71, request information indicating a first element included in the system, and a second element that is a target of determining whether or not an influence is felt when a change is made to the first element. In addition, the user can reference, via the output device 72, a determination result indicating whether or not an influence is felt by the second element when a change is made to the first element, as determined by the inter-element influence determination apparatus 1.

The input device 71 transmits the input request information to the inter-element influence determination apparatus 1. The output device 72, upon receiving determination result information from the inter-element influence determination apparatus 1, outputs the determination result information to the user via images or audio.

The inter-element influence determination apparatus 1 comprises a receiver 11, a system information storage device 12, a relationship information storage device 13, an influence determiner 14 and a transmitter 15.

The receiver 11 receives request information from the user terminal 7. The receiver 11 sends the request information received to the influence determiner 14.

The system information storage device 12 acquires from the system, system information relating to elements comprising the system, as necessary, and stores this information. The system information comprises identification information identifying elements recorded for each element, attribute information indicating attributes of elements, and/or the like. The element attributes indicate the type of element, location, related places, functions and/or the like. In addition, the attribute information includes target attribute information indicating materials or services provided to that element and/or materials or services that element provides to other elements, supplier attribute information indicating elements of suppliers of materials or services supplied to the element, and suppliee attribute information indicating elements of suppliees to which the element supplies materials or services.

In addition, the attribute information may include means attribute information indicating means for supplying materials or services. Means for supplying materials or services include, for example, vehicles, ships, aircraft, infrastructure locations and/or the like in cases in which attributes of elements are in the transportation industry, and medical structures and equipment and/or the like in cases in which the element attributes are medical. The means of supplying materials or services may include human resources. Furthermore, for example if the means include workers, the means may include detailed information about the means, such as the employment status, address, age, sex and/or the like.

The relationship information storage device 13 stores relationship information indicating relationships providing direct interaction among elements, in the elements of the system. A relationship providing direct interaction means, for example, a relationship in which one element provides materials or services to another element, a relationship in which two elements exist at the same place, and/or the like.

The influence determiner 14 acquires system information and relationship information relating to the request information, from the system information storage device 12 and the relationship information storage device 13. The influence determiner 14 creates a system network model modeling the system by causing the various elements included in the system to be virtually connected, on the basis of the acquired system information and relationship information. Following this, the influence determiner 14 determines whether or not there is an influence on the second element when a change is made to the first element, on the basis of the system network model created. The influence determiner 14 sends the determination result information indicating the results determined to the transmitter 15.

The transmitter 15 transmits the determination result information received from the influence determiner 14 to the user terminal 7.

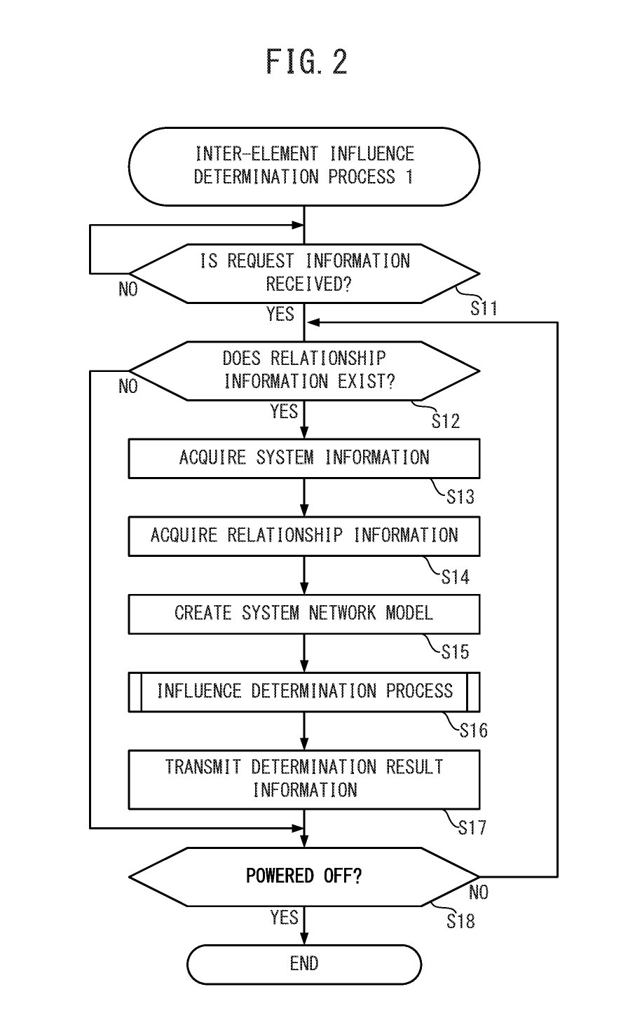

FIG. 2 is a flowchart showing one example of the actions of an inter-element influence determination process according to the first exemplary embodiment. The inter-element influence determination process 1 starts when the inter-element influence determination apparatus 1 is powered on.

The receiver 11 of the inter-element influence determination apparatus 1, upon receiving request information from the user terminal 7 (step S11: Yes), sends the request information received to the influence determiner 14. When request information has not been received from the user terminal 7 (step S11: No), step S11 is repeated.

The influence determiner 14 determines whether or not there is relationship information corresponding to the request information in the relationship information storage device 13 (step S12). Specifically, the influence determiner 14 determines whether or not relationship information relating to the second element included in the request information received is stored in the relationship information storage device 13. When relationship information corresponding to the request information received is not stored in the relationship information storage device 13 (step S12: No), the influence determiner 14 moves the process to step S18. When relationship information corresponding to the request information is stored in the relationship information storage device 13 (step S12: Yes), the influence determiner 14 acquires system information corresponding to the request information from the system information storage device 12 (step S13). Following this, the influence determiner 14 acquires the relationship information corresponding to the request information from the relationship information storage device 13 (step S14).

Next, the influence determiner 14 creates a system network model modeling the system by causing each of the elements in the system to be virtually connected on the basis of the acquired system information and relationship information (step S15). Following this, the influence determiner 14 executes an influence determination process (step S16). Through the influence determination process, the influence determiner 14 determines whether or not an influence is felt by the second element when a change is made to the first element indicated by the request information received. When the determination ends, the influence determiner 14 sends determination result information indicating the results determined by the influence determination process to the transmitter 15.

The transmitter 15 transmits to the user terminal 7 the determination result information received from the influence determiner 14 (step S17).

When the inter-element influence determination apparatus 1 is still powered on (step S18: No), the inter-element influence determination apparatus 1 returns the process to step S11, and after this repeats step S11 to step S18. When the inter-element influence determination apparatus 1 is powered off (step S18: Yes), the process ends.

Below, a specific explanation is given using examples in which the apparatus is applied to a purchasing system and a shipping system.

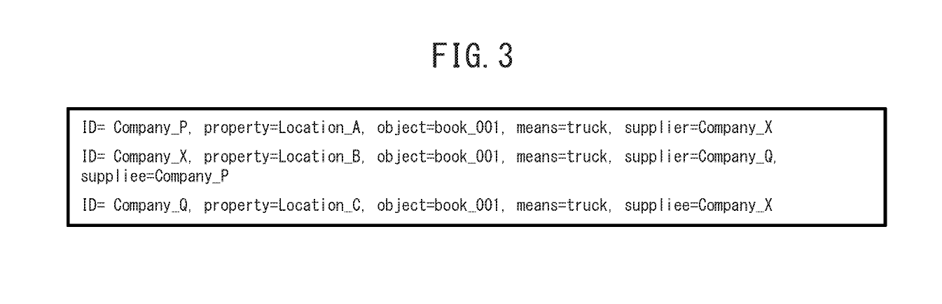

FIG. 3 is a diagram showing one example of system information according to the first exemplary embodiment. Here, for system information indicating elements of a purchasing system, when identification information (ID) is Company_P, position attribute information (property) is Location_A, object attribute information (object) is book_001, means attribute information (means) is truck, and supplier attribute information (supplier) is Company_X, the information is stored in the format “ID=Company_P, property=Location_A, object=book_001, means=truck, supplier=Company_X”.

For example, suppose that the user request indicating request information received by the receiver 11 is “determine the possibility of influence from element W of the shipping system on element P of the purchasing system”. In this case, with the request information received by the input device 71, the first element included in the system is element P and the second element for which determination is made as to whether or not there is an influence is element W. When this request information is received, the influence determiner 14 first extracts system information for the purchasing system including ID=Company_P (identification information of element P), from the system information storage device 12. When the extracted system information is “ID=Company_P, property=Location_A, object=book_001, means=truck, supplier=Company_X”, the influence determiner 14 extracts all of the system information including object=book_001 (system information for elements in which the object attribute information matches).

In the example in FIG. 3, the information including object=book_001 is “ID=Company_P, property=Location_A, object=book_001, means=truck, supplier=Company_X”, “ID=Company_X, property=Location B, object=book_001, means=truck, supplier=Company_Q, suppliee=Company_P” and “ID=Company_Q, property=Location_C, object=book_001, means=truck, suppliee=Company_X”.

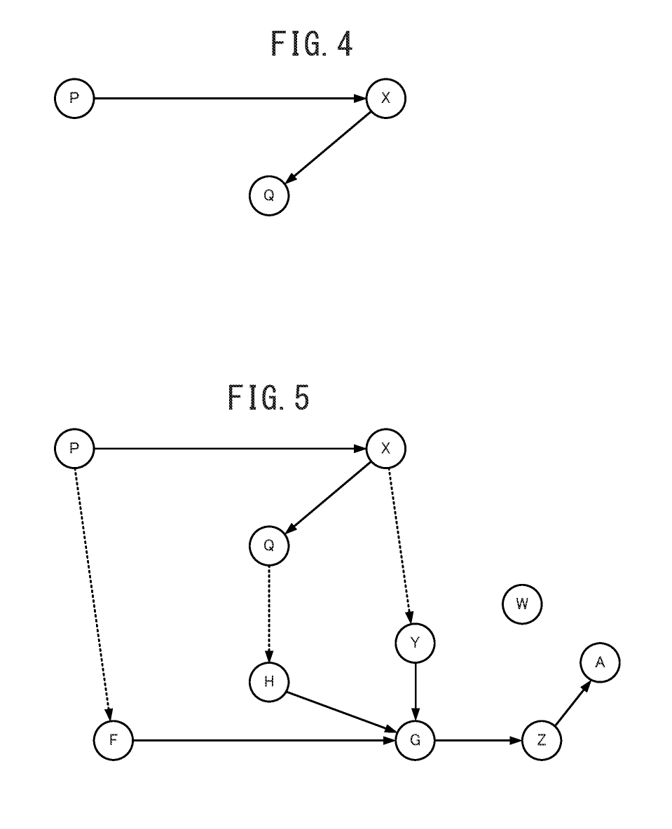

Next, the influence determiner 14 reads the relationship information inside the purchasing system from the relationship information storage device 13. Suppose that the relationship information read is “in the purchasing system, of the elements having the same object attribute information (information indicating the object is the same), two of the elements one of which is the supplier and the other of which is the suppliee (two elements having a relationship such that the identification information of one element is in the supplier attribute information (supplier) of the other element, and the identification of the other element is in the suppliee of the one element), have a relationship in which direct interaction is provided.” In this case, the influence determiner 14 determines that the element P is in a relationship that provides direct interaction with the element X, on the basis of the system information and relationship information read, and causes the element P and the element X to be virtually connected. In addition, similarly the influence determiner 14 determines that the element X and the element Q are in a relationship that provides direct interaction, and causes the element X and the element Q to be virtually connected. As a result, the influence determiner 14 creates a system network model such as is shown in FIG. 4.

FIG. 4 is a schematic diagram showing one example of a network model for a purchasing system created by the actions of the influence determiner 14 described to this point. In this exemplary embodiment, the inter-element influence determination apparatus 1 can determine whether or not another element receives an influence when changes are made to a given element, in the purchasing system, by creating this kind of system network model.

Following this, the influence determiner 14 reads the relationship information indicating relationships among elements of the purchasing system and the shipping system, from the relationship information storage device 13. Specifically, the influence determiner 14 reads the relationship information relating to the various elements (element P, element X, element Q) of the purchasing system.

The influence determiner 14 extracts system information indicating the elements of the shipping system related to the above-described elements (element P, element X, element Q), from the system information storage device 12, referencing the relationship information that was read. As one example, an example is shown here in which element F is related to element P, element H is related to element Q and element Y is related to element X. The influence determiner 14 creates the system network model shown in FIG. 5, in accordance with the system information and relationship information read.

FIG. 5 is a schematic diagram showing one example of a system network model created by the actions of the influence determiner 14 described to this point. In the example in FIG. 5, element P of the purchasing system is connected to element F of the shipping system. Element X of the purchasing system is connected to element Y of the shipping system. Element Q of the purchasing system is connected to element H of the shipping system.

In addition, it would be fine for the system information storage device 12 to acquire and store event information indicating events related to the element attribute information. Here, the event information may be recorded in the system information storage device 12 through the operator of the system or service. Or, when specified or unspecified multiple users transmit event information, the inter-element influence determination apparatus 1 may automatically record the information in the system information storage device 12.

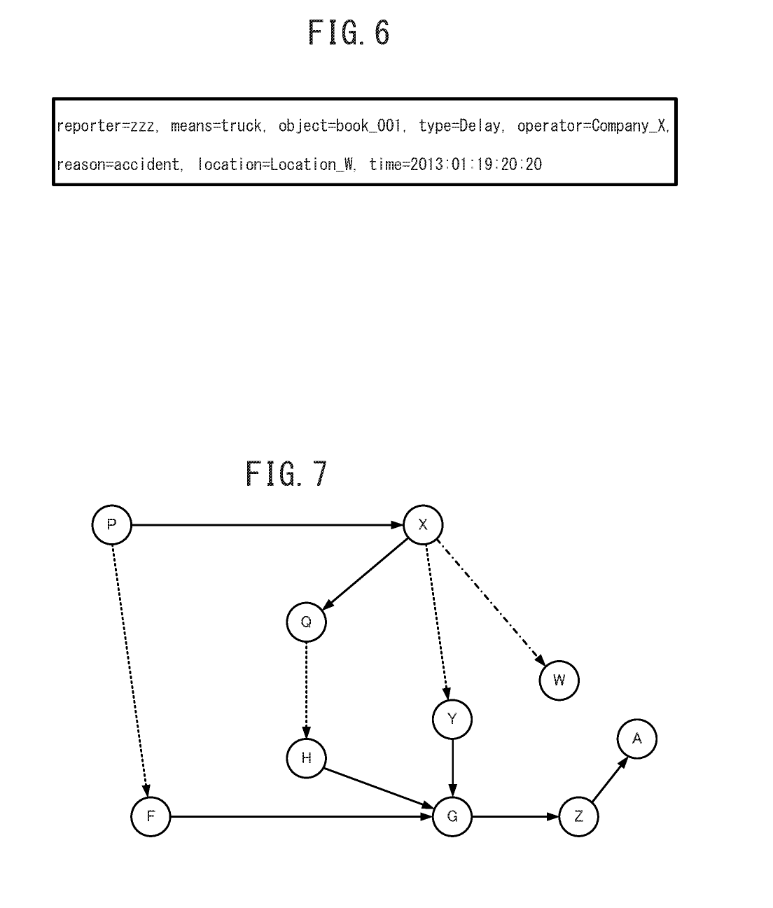

FIG. 6 is a drawing showing one example of event information according to the first exemplary embodiment. For example, the event information comprises means attribute information (means) indicating the means of supplying materials or services of elements related to the event, object attribute information (object) indicating the materials or services being handled by elements related to the event, type information (type) indicating the type of the event, operator information (operator) indicating elements related to the event, location information (location) indicating the occurrence location of the event, time information (time) indicating the occurrence time of the event, and/or the like.

In the example in FIG. 6, reporter information indicating a reporter who reported the event is zzz, the means attribute information is track, the object attribute information is book_001, the type information is delay, the operator information is Company_X, the reason information indicating the reason for the event's occurrence is accident, the location information is Location_W and the time information is 2013:01:19:20:20. As shown in FIG. 6, the event information indicating this event is recorded in the format, “reporter=zzz, means=truck, object=book_001, type=Delay, operator=Company_X, reason=accident, location=Location_W, time=2013:01:19:20:20”.

The influence determiner 14 extracts event information including object=book_001 as shown in FIG. 6, from the system information storage device 12. As one example, consider a case in which relationship information (event occurrence time relationship information) defining the relationship among elements at the time the event occurred of “in the shipping system, when an event for which reason=accident occurs, the element corresponding to the operator of the event information and the element corresponding to location are in a relationship providing direct interaction” is recorded in the relationship information storage device 13. In this case, the influence determiner 14 creates a system network model on the basis of the event occurrence time relationship information. Specifically, because the operator information (operator) recorded in the above-described event information matches the identification information (ID) of the element X and the location information (location) recorded in the event information matches the position attribute information (property) of the element W, the system network model is created by connecting the element X and the element W.

FIG. 7 is a schematic diagram showing one example of a system network model taking events into consideration, created by above-described actions of the influence determiner 14. In the example in FIG. 7, in addition to the contents shown in FIG. 5, the element X of the purchasing system and the element W of the shipping system are further connected.

The influence determiner 14, having thus created the system network model, determines whether or not there is an influence among the elements of the system requested by the user.

In the examples shown in FIG. 3 through FIG. 7, the explanation given was for cases in which the system information indicating the elements of the purchasing system included the identification information “Company_P”, the position attribute information “Location_A”, the object attribute information “book_001”, the means attribute information “truck” and the supplier attribute information “Company_X”, but this is intended to be illustrative and not limiting. The system information can include arbitrary attribute information.

For example, when the user request indicating the request information received by the receiver 11 is “determine the possibility of influence from the element W of the shipping system on the element P of the purchasing system”, the influence determiner 14 first extracts system information of the purchasing information including ID=Company_P, from the system information storage device 12.

Next, the influence determiner 14 reads from the relationship information storage device 13 relationship information indicating rules expressing relationships among elements of “two elements in which the position attribute information (property) matches are in a relationship providing direct interaction”. For example, when the system information of the element P of the purchasing system is “Company=Company_P, property=Location_A” and the system information of the element F of the shipping system is “TransportNode=F, property=Location_A”, the element P of the purchasing system and the element F of the shipping system are connected.

Furthermore, the influence determiner 14 reads from the relationship information storage device 13 relationship information indicating rules expressing relationships among elements of “in the system shipping, elements for which paths are linked are in a relationship providing direct interaction with each other”. Suppose that the paths of the shipping system are set beforehand. The influence determiner 14 connects elements for which paths are linked with the element F of the shipping system, and creates a system network model. Having done this, the influence determiner 14 determines the possibility of influence from the element W of the shipping system on the element P of the purchasing system.

From here, the influence determination process defined in step S16 of the flowchart in FIG. 2 is described.

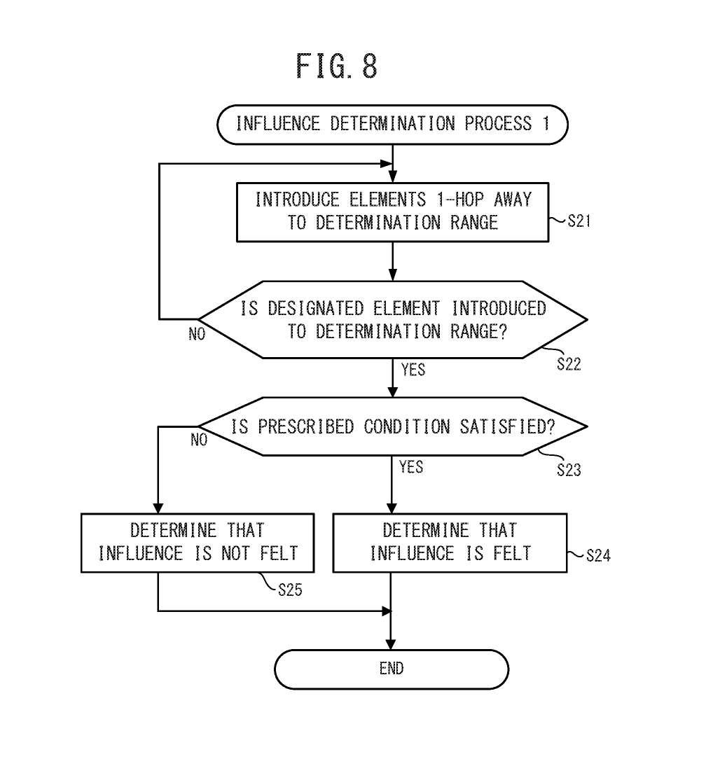

FIG. 8 is a flowchart showing one example of the actions of an influence determination process 1 according to the first exemplary embodiment. The influence determiner 14 starts the influence determination process 1 upon receiving request information from the receiver 11.

First, the influence determiner 14 calculates to what extent the element for which change is hypothesized (the first element) and the element that is the object of determining whether or not an influence is felt (the second element) are separated, in the system network model created in step S15 of the flowchart in FIG. 2. Specifically, the influence determiner 14, referencing the request information, initially introduces an element one hop away from the second element in the system network model into a determination range (step S21). A hop is a unit of the number of partial paths traversed to reach the target element, and an element one hop away is a neighboring element directly connected without going through another element.

When the result of step S21 is that the first element is not included in the determination range (step S22: No), the process returns to step S21, the determination range is expanded and elements a further one hop away from elements included in the determination range in the present state are introduced into the determination range. This step S21 and step S22 are repeated until the first element is included in the determination range, and the number of repetitions is counted, and through this the influence determiner 14 calculates to what extent the first element and the second element are separated (how many hops).

When the first element is included in the determination range (step S22: Yes), the influence determiner 14 determines whether or not the first element and the second element satisfy a prescribed condition (step S23). The prescribed condition is a condition such as the number of hops from the first element to the second element, or the number of paths from the first element to the second element, in the system network model, and/or the like.

When the prescribed condition is satisfied (step S23: Yes), a determination is made that there is an influence from the designated element on the element for which a determination is requested (step S24), and the process concludes.

When the prescribed condition is not satisfied (step S23: No), a determination is made that there is no influence from the designated element on the element for which the user requested a determination (step S25), and the process concludes.

In the influence determination process 1 illustrated to this point, the determination range is decided and a determination as to whether or not there is influence is determined at the point in time when the designated element is introduced into the determination range. However, the present disclosure is not limited to this, for it would be fine to use the below-described influence determination process 2. From here, the influence determination process 2 for determining whether or not there is an influence based on whether or not the designated element is included in an influence range restricted by prescribed range conditions is explained.

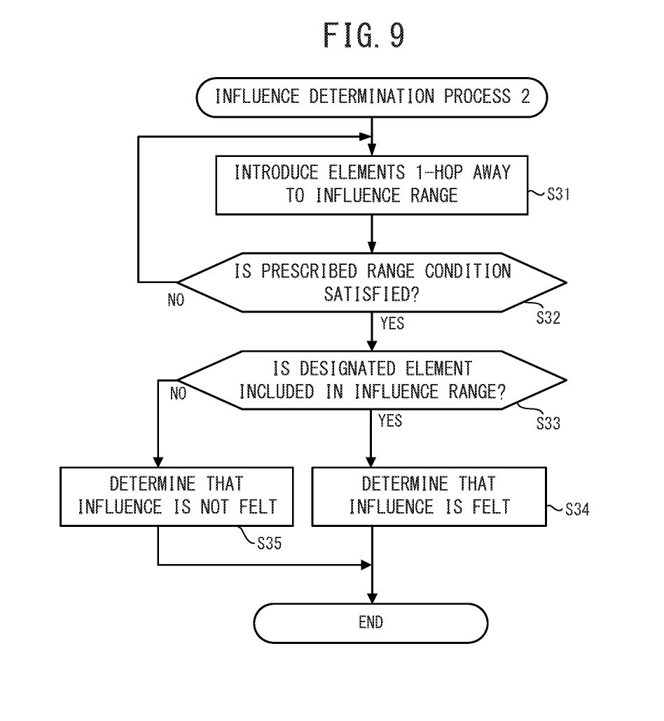

FIG. 9 is a flowchart showing one example of the actions of an influence determination process 2 according to the first exemplary embodiment. The influence determiner 14 starts the influence determination process 2 upon receiving request information from the receiver 11.

First, the influence determiner 14 determines whether or not the element for which change is hypothesized (the first element) and element that is the object of determining whether or not an influence is felt (the second element) are in a range that satisfies a prescribed range condition, in the system network model created in step S15 of the flowchart in FIG. 2. The prescribed range condition is specifically the hop number from the first element to the second element, the number of elements included in the influence range, and/or the like. As one example, the influence determiner 14 first introduces elements separated by one hop from the second element into the influence range (step S31).

Next, the influence determiner 14 determines whether or not the influence range introduced in step S31 satisfies the prescribed range condition. Specifically, the influence determiner 14 determines whether or not the current influence range reaches as far as a range of a prescribed hop number or greater from the second element, or if the number of elements included in the present influence range reaches a prescribed number or greater. When the current influence range does not satisfy the prescribed range condition (step S32: No), the process returns to step S31 and the influence determiner 14 introduces into the influence range elements a further one hop away from the elements introduced into the influence range.

When the influence range satisfies the prescribed range condition (step S32: Yes), the influence determiner 14 determines whether or not the first element is included in the current influence range (step S33).

When the first element is included in the influence range (step S33: Yes), the influence determiner 14 determines that changes to the first element provide an influence on the second element (step S34), and the process concludes.

When the first element is not included in the influence range (step S33: No), the influence determiner 14 determines that changes to the first element do not provide an influence on the second element (step S35), and the process concludes.

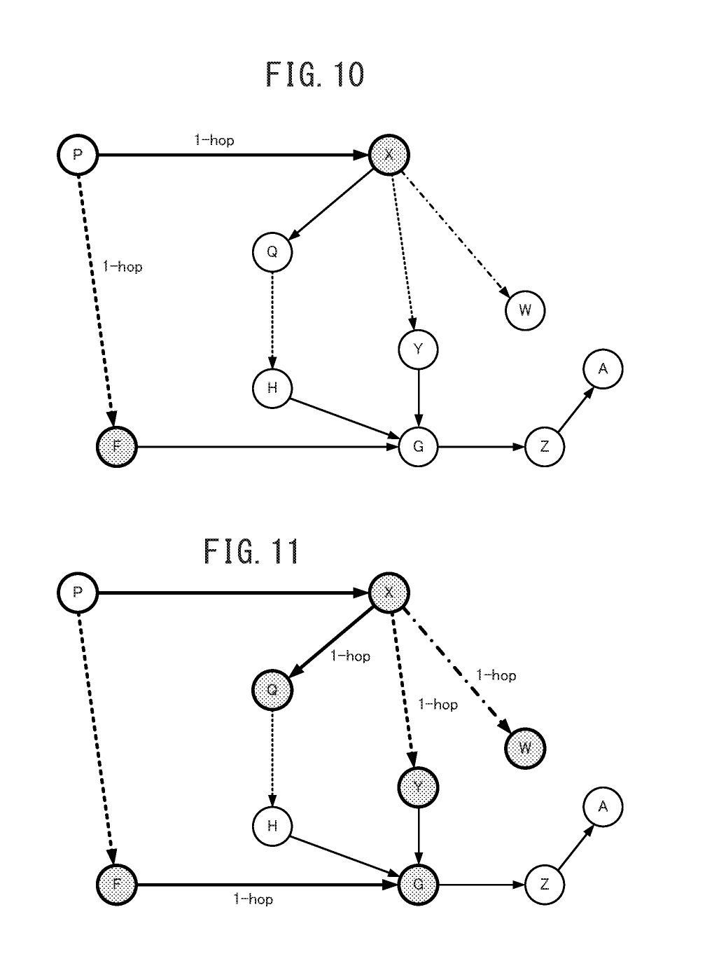

The influence determination process 1 is described in detail using FIG. 10 and FIG. 11, while referencing FIG. 8.

FIG. 10 is a schematic diagram showing a system network model according to the first exemplary embodiment. As described above, when the user request indicating request information is “determine the influence from the element W of the shipping system on the element P of the purchasing system”, the element W corresponds to the first element and the element P corresponds to the second element. The influence determiner 14 introduces into the determination range element X and element F one hop away from the element P (the second element) for which the user is requesting a determination of the possibility of influence, in the system network model shown in FIG. 10 (step S21). However, at this step, the element W that is the first element is not yet included in the determination range, as shown in FIG. 10.

Following step S21, the influence determiner 14 determines whether or not the first element (element W) is included in the determination range (step S22). However, as noted above, the element W has not yet been introduced into the determination range, so the influence determiner 14 determines that the first element is not included in the determination range (step S22: No). Having done this, the influence determiner 14 returns the process to step S21 and, as shown in FIG. 11, introduces into the determination range the element G, the element Q, the element Y and the element W a further one hop away from the element X and the element F (step S21). Through this, the element W, which is the first element, is included in the determination range.

Because the first element (element W) is included in the determination range, the influence determiner 14 determines that the first element is included in the determination range (step S22: Yes). Next, the influence determiner 14 determines whether or not the element P for which the user has requested a determination of the possibility of influence (second element) and the designated element W (first element) satisfy a prescribed condition, based on the elements in the determination range of the system network model (step S23). Here, suppose that the prescribed condition is “there is a path from the element W to the element P”.

The influence determiner 14 determines that one path exists (the path from element W to element P via element X) from the element W to the element P of the purchasing system, based on the system network model. Having done this, because one path exists from the element W of the shipping system to the element P of the purchasing system (step S23: Yes), the influence determiner 14 determines that there is an influence from the first element on the second element (step S24), and concludes the process.

The influence determination process 2 is described in detail using FIG. 10 and FIG. 11, while referencing FIG. 9.

In FIG. 10 and FIG. 11, a prescribed range condition is shown taking as an example “up to 2 hops from the element for which the user is requesting a determination of the possibility of influence.” As noted above, when the request from the user indicating request information is “determine the influence from the element W of the shipping system (first element) on the element P of the purchasing system (second element)”, the influence determiner 14 references the system network and introduces into the influence range the element X and the element F one hop from the element P, which is the second element for which the user is requesting a determination of the possibility of influence, as shown in FIG. 10 (step S31).

Because the current influence range does not satisfy the prescribed range condition (step S32: No), the influence determiner further introduces into the influence range the element G, the element Q, the element Y and the element W one hop from the element X and the element Y, as shown in FIG. 11 (step S31).

Because the influence range satisfies the prescribed range condition (step S32: Yes), the influence determiner 14 determines whether or not the element W (first element) designated in the influence range is included (step S33). As a result, the influence determiner 14 determines that the element W designated in the influence range is included (step S33: Yes), determines that there is an influence on the element P of the purchasing system from the element W of the shipping system (step S34), and concludes the process.

In the description to this point, the description was for cases in which the user request was seeking a determination of whether or not an influence is provided to the second element when a change is made to the first element included in the system. However, the inter-element influence determination system 100 of this exemplary embodiment is not limited to this, for it would be fine to receive request information with multiple elements as the first element. In this case, the input device 71 receives an input of request information such as “determine the possibility of influence from elements in the range of one hop including the shipping system, on the element P of the purchasing system”, for example, from the user. In this manner, when request information including multiple elements as the first element is received, the influence determiner 14 determines whether or not there is an influence on the element received as the second element (element P) from each of the multiple elements received as the first element.

As described above, the inter-element influence determination system 100 of the first exemplary embodiment creates a system network model based on attribute information and relationship information, and determines whether or not there is an influence on a second element when changes are made to a first element based on the system network model created. Because the process is accomplished based on attribute information and relationship information recorded by a general system, not much cost arises and it is possible to make a determination at low cost. In addition, because the determination is made based on the system network model, it is possible to make determinations even between elements having no direct interaction (between elements having a relationship separated by 2 hops or more). In this manner, with this disclosure, it is possible to determine the absence or presence of influence even among elements with no direct interaction, at low cost. Consequently, it is possible to mitigate the possibility of making an erroneous determination for the causes of changes in a system.

With this exemplary embodiment, it is determined that there is an influence (the degree of influence is not zero) when the element for which a user is requesting a determination of the possibility of influence and the designated element satisfy a prescribed condition within a determination range, or if an element designated in an influence range satisfying a prescribed range condition is included. This kind of determination result can be used as a pretreatment for detailed analysis.

In addition, by making a detailed analysis of the degree of influence only on elements for which it has been determined by this disclosure that there is an influence, it is possible to reduce the number of elements related to the analysis, making it possible to efficiently accomplish analysis. In particular, when the number of elements is enormous, by determining the possibility of influence when the designated element is included in an influence range satisfying a prescribed range condition as in the latter case, it is possible to reduce the number of elements being examined in detail, which is effective.

### Second Exemplary Embodiment

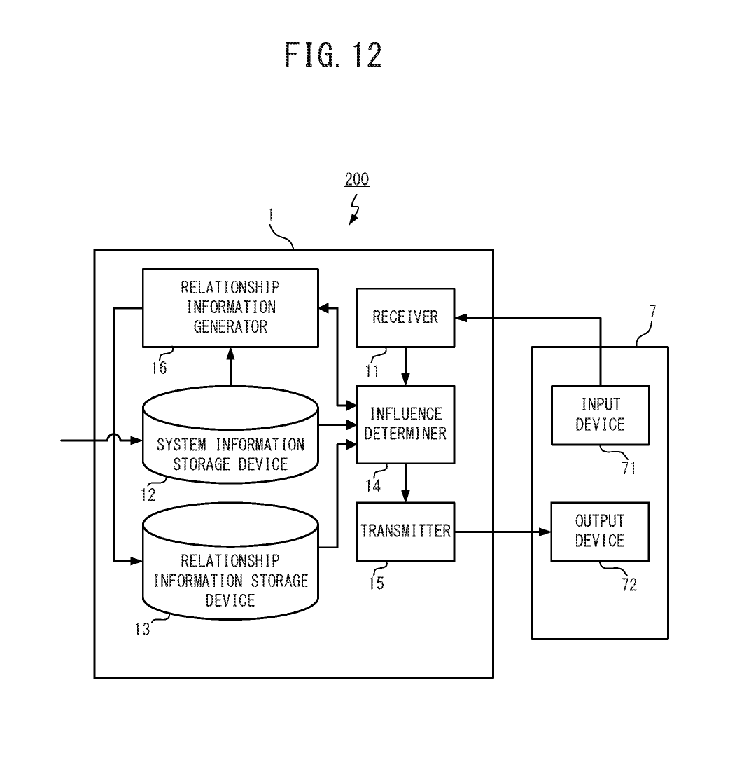

FIG. 12 is a block diagram showing an exemplary configuration of an inter-element influence determination system according to a second exemplary embodiment of the present disclosure. An inter-element influence determination system 200 of the second exemplary embodiment comprises the inter-element influence determination apparatus 1 and the user terminal 7, the same as the inter-element influence determination system 100 of the first exemplary embodiment. In addition, the inter-element influence determination apparatus 1 of the second exemplary embodiment comprises a relationship information generator 16, in addition to the configuration of the inter-element influence determination apparatus 1 of the first exemplary embodiment.

When there is no relationship information corresponding to the request information in the relationship information storage device 13, the influence determiner 14 transmits instructions to generate relationship information to the relationship information generator 16.

The relationship information generator 16, upon receiving instructions to generate relationship information from the influence determiner 14, acquires system information relating to the request information from the system information storage device 12. The relationship information generator 16 finds the relationships among elements of the system from acquired system information, based on rules set in advance, defines the relationships and generates relationship information. The relationship information generator 16 records the generated relationship information in the relationship information storage device 13. Specific examples of relationships include “attribute citation”, “attribute equivalence”, “common citation” and/or the like.

“Attribute citation” is defined as a relationship between a given element and another element when the given element and the other element mutually cite attributes that are paired. For example, a case can be conceived in which one element cites the other element in attribute information of the supplier, while the other element cites the first element in attribute information for the suppliee paired with the supplier. This may be defined in advance, or may be automatically generated using a thesaurus and/or the like.

“Attribute equivalence” means two elements are considered equivalent if the two satisfy a given condition. The given condition is, for example, “buildings within 100 m are considered to exist in the same location.” This may be defined in advance in the system, or may be designated by the user when a request is received from the user.

“Common citation” indicates a case in which two elements or attributes included in the elements are both cited within separate data. For example, in the event information shown in FIG. 6, Company_X and Location_W appear in the same event information, so it can be determined that there is a relationship.

The relationship information generator 16 notifies the influence determiner 14 that relationship information corresponding to the request information has been recorded in the relationship information storage device 13. The influence determiner 14, upon receiving this notification, acquires the relationship information corresponding to the request information from the relationship information storage device 13. Other parts of the configuration are the same as the first exemplary embodiment.

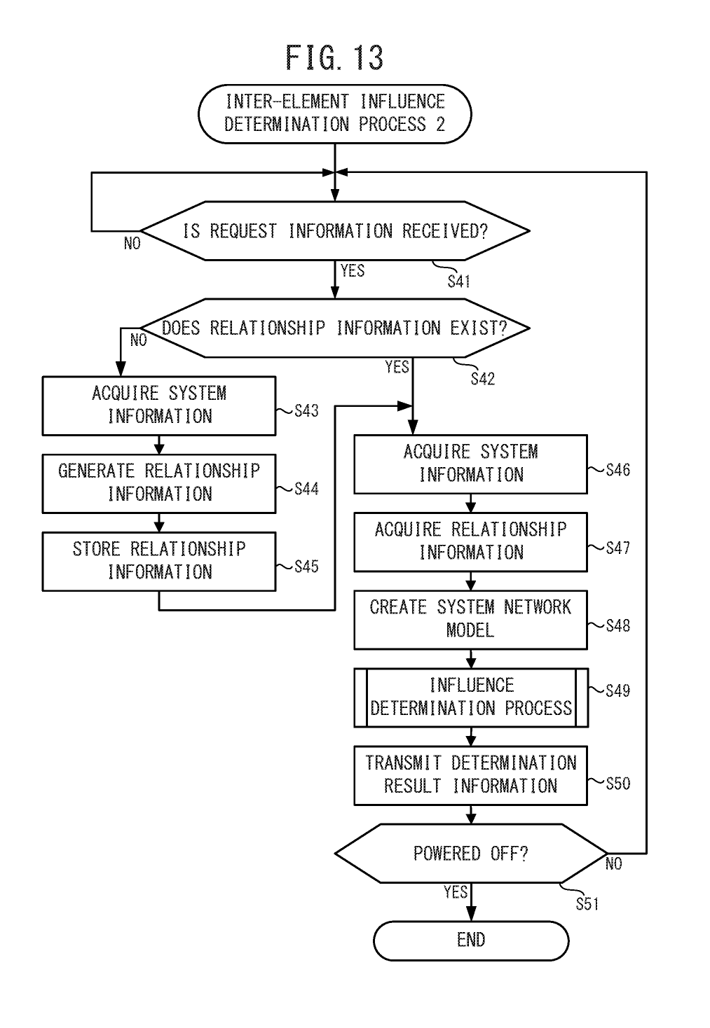

FIG. 13 is a flowchart showing one example of the actions of an influence determination process according to the second exemplary embodiment. The inter-element influence determination process 2 starts when the inter-element influence determination apparatus 1 is powered on.

The receiver 11 of the inter-element influence determination apparatus 1, upon receiving request information from the user terminal 7 (step S41: Yes), transmits the request information received to the influence determiner 14. When request information is not received from the user (step S41: No), step S41 is repeated.

The influence determiner 14 determines whether or not there is relationship information corresponding to the request information in the relationship information storage device 13 (step S42). When the relationship information corresponding to the request information is acquired (step S42: Yes), the influence determiner 14 moves the process to step S46.

When there is no relationship information corresponding to the request information (step S42: No), the influence determiner 14 transmits to the relationship information generator 16 a command to generate relationship information corresponding to the request information.

The relationship information generator 16, upon receiving the command to generate relationship information corresponding to the request information from the influence determiner 14, acquires system information corresponding to the request information from the system information storage device 12 (step S43). The relationship information generator 16 finds relationships from the acquired system information, defines the relationships and generates relationship information (step S44).

The relationship information generator 16 records the generated relationship information in the relationship information storage device 13 (step S45). When this information is recorded, the relationship information generator 16 notifies the influence determiner 14 that relationship information corresponding to the request information has been recorded in the relationship information storage device 13.

The influence determiner 14 acquires the system information corresponding to the request information from the system information storage device 12 (step S46). The influence determiner 14 acquires relationship information corresponding to the request information from the relationship information storage device 13 (step S47).

The influence determiner 14 creates a system network model modeling the system by virtually connecting the various elements included in the system on the basis of the acquired system information and relationship information (step S48). Next, the influence determiner 14 executes an influence determination process (step S49). Through the influence determination process, the influence determiner 14 determines whether or not there is an influence on the second element when a change is made to the first element indicated by the request information received. The influence determiner 14 transmits determination result information indicating the results of the determination by the influence determination process to the transmitter 15.

The transmitter 15 transmits the determination result information received from the influence determiner 14 to the user terminal 7 (step S50).

When the inter-element influence determination apparatus 1 is still powered on (step S51: No), the inter-element influence determination apparatus 1 returns the process to step S41 and thereafter repeats step S41 through step S51. When the inter-element influence determination apparatus 1 has been powered off (step S51: Yes), the process concludes.

As described above, with the inter-element influence determination system 200 of the second exemplary embodiment, even when there is no relationship information corresponding to the request information in the relationship information storage device 13, it is possible to determine the possibility of influence among elements of a system requested by the user, by newly generating relationship information from the system information.

With the above-described exemplary embodiments, a determination is made as to whether or not making a change to one element has an influence on another element, among elements designated by the user. However, this is intended to be illustrative and not limiting, for it would also be fine to calculate a degree of influence indicating the extent to which there is an influence on the other element when a change is made to the one element designated by the user. For example, when calculating the degree of influence on element A from element B, when there are m elements, including element B, existing in the path supplying the same materials or services to element A, the degree of influence of element B on element A is taken to be 1/m. Or, when the number of paths from element B to element A is m, the degree of influence of element B on element A may be taken to be m.

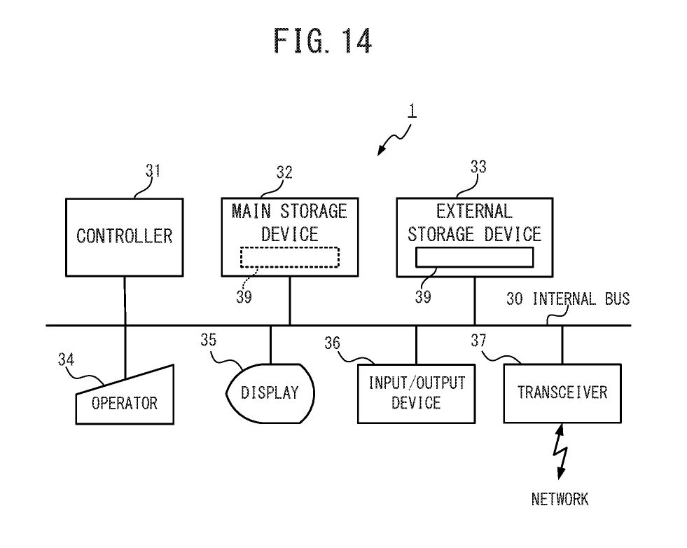

FIG. 14 is a block diagram showing one example of a hardware configuration of an inter-element influence determination apparatus according to the exemplary embodiments of the present disclosure. As shown in FIG. 14, the inter-element influence determination apparatus 1 comprises a controller 31, a main storage device 32, an external storage device 33, an operator 34, a display 35, an input/output device 36 and a transceiver 37. The main storage device 32, the external storage device 33, the operator 34, the display 35, the input/output device 36 and the transceiver 37 are all connected to the controller 31 via an internal bus 30.

The controller 31 comprises a central processing unit (CPU) and/or the like, and executes various processes of the influence determiner 14 and the relationship information generator 16 of the inter-element influence determination apparatus 1 by following a control program 39 stored in the external storage device 33.

The main storage device 32 comprises random access memory (RAM) and/or like, loads the control program 39 stored in the external storage device 33 and is used as a work area for the controller 31.

The external storage device 33 comprises non-volatile memory such as a flash memory, a hard disk, a digital versatile disc random-access memory (DVD-RAM), a digital versatile disc rewriteable (DVD-RW) and/or the like. The external storage device 33 stores in advance programs for causing the controller 31 to execute the processes of the inter-element influence determination apparatus 1, and in addition, supplies to the controller 31 data stored by these programs, and stores data supplied from the controller 31, in accordance with commands from the controller 31. The system information storage device 12 and the relationship information storage device 13 are comprised of the external storage device 33.

The operator 34 comprises a keyboard and a pointing device such as a mouse and/or the like, and an interface device that connects the keyboard and the pointing device and/or the like to the internal bus 30. When the user is directly inputting information into the inter-element influence determination apparatus 1, the input information is supplied to the controller 31 via the operator 34. When the user terminal of FIG. 1 and FIG. 12 has a configuration included in the inter-element influence determination apparatus 1, the operator 34 functions as the input device 71.

The display 35 comprises a cathode ray tube (CRT), a liquid crystal display (LCD) and/or the like, and displays an operation screen when the user directly inputs information into the inter-element influence determination apparatus 1. When the user terminal of FIG. 1 and FIG. 12 has a configuration included in the inter-element influence determination apparatus 1, the display 35 functions as the output device 72.

The input/output device 36 comprises a serial interface or a parallel interface. When the user terminal of FIG. 1 and FIG. 12 is a device attached to the inter-element influence determination apparatus 1, the input/output device 36 is connected to the user terminal 7.

The transceiver 37 comprises a network terminal device connected to a network or a wireless communication apparatus, and a serial interface or a local area network (LAN) interface connected to these. The transceiver 37 connects to the user terminal 7 and the inter-element influence determination apparatus 1 via a network. The transceiver 37 functions as the receiver 11 and the transmitter 15.

The processes of the receiver 11, the system information storage device 12, the relationship information storage device 13, the influence determiner 14 and the transmitter 15 of the inter-element influence determination apparatus 1 shown in FIG. 1 and FIG. 12 are executed by the control program 39 conducting processes using as resources the controller 31, the main storage device 32, the external storage device 33, the operator 34, the display 35, the input/output device 36, the transceiver 37 and/or the like.

Besides this, the above-described hardware configuration and flowcharts are but one example, and arbitrary modifications and changes are possible.

The components at the heart of conducting the inter-element influence determination process comprising the controller 31, the main storage device 32, the external storage device 33, the operator 34, the display 35, the input/output device 36, the transceiver 37, the internal bus 30 and/or the like need not be realized with a dedicated system, but can be realized using a regular computer system. For example, the inter-element influence determination apparatus 1 for executing the above-described processes may be configured by a computer program for executing the above-described actions being stored and distributed on a non-transitory computer-readable recording medium (a flexible disc, CD-ROM, DVD-ROM and/or the like), and the computer program being installed on a computer. In addition, the inter-element influence determination apparatus 1 may be configured by the computer program being stored on a storage device having a server device on a communication network such as the Internet and/or the like, and being downloaded and/or the like by a regular computer system.

In addition, when the functions of the inter-element influence determination apparatus 1 are divided between an operating system (OS) and application programs or are realized by cooperation between an OS and application programs, it would be fine to store only the application program portion on the recording medium or storage device.

In addition, the computer program can be overlaid on carrier waves and distributed via a communication network. For example, the computer program may be posted on a bulletin board system (BBS) on a communication network and the computer program may be distributed via the network. Furthermore, it would be fine to have a configuration such that the above-described processes can be executed by this computer program being activated and being executed similar to other application programs under control of the OS.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

All or a portion of the above-described exemplary embodiment is also noted in the supplementary notes below, but are not limited thereby.

(Supplementary Note 1)

An inter-element influence determination system comprising a user terminal and an inter-element influence determination apparatus connected by a network, wherein:

the user terminal comprises:

an input device that acquires request information indicating a first element included in a system and a second element that is a target for determining whether or not an influence is felt when changes are made to the first element, based on user input, and transmits the request information to the inter-element influence determination apparatus; and

an output device that outputs information received from the inter-element influence determination apparatus to a user; and

the inter-element influence determination apparatus comprises:

a receiver that receives the request information from the user terminal;

a system information storage device that stores system information including attribute information indicating attributes of various elements of the system;

a relationship information storage device that stores relationship information indicating relationships providing direct interaction among the elements in the system;

an influence determiner that creates a system network model that models the system by virtually connecting the various elements included in the system on the basis of the system information and the relationship information, and determines whether or not an influence is felt by the second element indicated by the received request information when changes are made to the first element indicated by the received request information, based on the system network model created; and

a transmitter that transmits to the user terminal determination result information indicating results determined by the influence determiner.

(Supplementary Note 2)

The inter-element influence determination system according to Supplementary Note 1, wherein:

the attribute information includes, for each element, target attribute information indicating materials or services supplied to the element and/or materials or services the element supplies to other elements, supplier attribute information indicating elements that are suppliers of materials or services supplied to the element, and suppliee attribute information indicating the other elements that are suppliees of materials or services supplied by the element; and

the influence determiner creates the system network model by causing elements that are suppliers of the materials or services and elements that are suppliees of the materials or services to be connected, based on the attribute information.

(Supplementary Note 3)

The inter-element influence determination system according to Supplementary Note 1 or 2, wherein:

the system information storage device further acquires and stores event information indicating an event related to the attribute information of an element; and

the relationship information includes event occurrence time relationship information indicating a relationship providing direct interaction among elements while the event is occurring.

(Supplementary Note 4)

The inter-element influence determination system according to any one of Supplementary Notes 1 to 3, wherein:

the inter-element influence determination apparatus further comprises a relationship information generator that generates the relationship information from the system information by finding relationships among elements of the system based on rules established in advance.

(Supplementary Note 5)

An inter-element influence determination apparatus, comprising:

an acquirer that acquires request information indicating a first element included in a system, and a second element that is a target of determining whether or not an influence is felt when a change is made to the first element, based on user input;

a system information storage device that stores system information including attribute information indicating attributes of various elements of the system;

a relationship information storage device that stores relationship information indicating relationships providing direct interaction among the elements, in the system; and

an influence determiner that creates a system network model that models the system by virtually connecting the various elements included in the system on the basis of the system information and the relationship information, and determines whether or not an influence is felt by the second element indicated by the received request information when changes are made to the first element indicated by the received request information, based on the system network model created.

(Supplementary Note 6)

The inter-element influence determination apparatus according to Supplementary Note 5, wherein:

the attribute information includes, for each element, target attribute information indicating materials or services supplied to the element and/or materials or services the element supplies to other elements, supplier attribute information indicating elements that are suppliers of materials or services supplied to the element, and suppliee attribute information indicating the other elements that are suppliees of materials or services supplied by the element; and

the influence determiner creates the system network model by causing elements that are suppliers of the materials or services and elements that are suppliees of the materials or services to be connected, based on the attribute information.

(Supplementary Note 7)

The inter-element influence determination apparatus according to Supplementary Note 5 or 6, wherein:

the system information storage device further acquires and stores event information indicating an event related to the attribute information of an element; and

the relationship information includes event occurrence time relationship information indicating a relationship providing direct interaction among elements while the event is occurring.

(Supplementary Note 8)

The inter-element influence determination apparatus according to any one of Supplementary Notes 5 to 7, further comprising a relationship information generator that generates the relationship information from the system information by finding relationships among elements of the system based on rules established in advance.

(Supplementary Note 9)

An inter-element influence determination method, including:

acquiring request information indicating a first element included in a system, and a second element that is a target of determining whether or not an influence is felt when a change is made to the first element, based on user input;

creating a system network model that models the system by virtually connecting the various elements included in a system on the basis of system information including attribute information indicating attributes of various elements of the system and relationship information indicating relationships providing direct interaction among elements in the system; and

determining whether or not an influence is felt by the second element indicated by the acquired request information when changes are made to the first element indicated by the acquired request information, based on the created system network model.

(Supplementary Note 10)

A recording medium on which is recorded a program that causes a computer to function as:

acquisition means that acquires request information indicating a first element included in a system, and a second element that is a target of determining whether or not an influence is felt when a change is made to the first element, based on user input;

creation means that creates a system network model that models the system by virtually connecting the various elements included in a system on the basis of system information including attribute information indicating attributes of various elements of the system and relationship information indicating relationships providing direct interaction among elements, in the system; and

influence determination means that determines whether or not an influence is felt by the second element indicated by the acquired request information when changes are made to the first element indicated by the acquired request information, based on the system network model created by the creation means.

This application claims the benefit of Japanese Patent Application No. 2013-205306, filed on Sep. 30, 2013, the entire disclosure of which is incorporated by reference herein.

### REFERENCE SIGNS LIST

1 Inter-element influence determination apparatus
7 User terminal
11 Receiver
12 System information storage device
13 Relationship information storage device
14 Influence determiner
15 Transmitter
16 Relationship information generator
30 Internal bus
31 Controller
32 Main storage device
33 External storage device
34 Operator
35 Display
36 Input/output device
37 Transceiver
39 Control program
71 Input device
72 Output device
100, 200 Inter-element influence determination system

1. An inter-element influence determination system comprising a user terminal and an inter-element influence determination apparatus connected by a network, wherein:
the user terminal comprises:
an input device that acquires request information indicating a first element included in a system and a second element that is a target for determining whether or not an influence is felt when changes are made to the first element, based on user input, and transmits the request information to the inter-element influence determination apparatus; and
an output device that outputs information received from the inter-element influence determination apparatus to a user; and
the inter-element influence determination apparatus comprises:
a receiver that receives the request information from the user terminal;
a system information storage device that stores system information including attribute information indicating attributes of various elements of the system;
a relationship information storage device that stores relationship information indicating relationships providing direct interaction among the elements in the system;
an influence determiner that creates a system network model that models the system by virtually connecting the various elements included in the system on the basis of the system information and the relationship information, and determines whether or not an influence is felt by the second element indicated by the received request information when changes are made to the first element indicated by the received request information, based on the system network model created; and
a transmitter that transmits to the user terminal determination result information indicating results determined by the influence determiner.

2. The inter-element influence determination system according to claim 1, wherein:
the attribute information includes, for each element, target attribute information indicating materials or services supplied to the element and/or materials or services the element supplies to other elements, supplier attribute information indicating elements that are suppliers of materials or services supplied to the element, and suppliee attribute information indicating the other elements that are suppliees of materials or services supplied by the element; and
the influence determiner creates the system network model by causing elements that are suppliers of the materials or services and elements that are suppliees of the materials or services to be connected, based on the attribute information.

3. The inter-element influence determination system according to claim 1, wherein:
the system information storage device further acquires and stores event information indicating an event related to the attribute information of an element; and
the relationship information includes event occurrence time relationship information indicating a relationship providing direct interaction among elements while the event is occurring.

4. The inter-element influence determination system according to claim 1, wherein:
the inter-element influence determination apparatus further comprises a relationship information generator that generates the relationship information from the system information by finding relationships among elements of the system based on rules established in advance.

5. An inter-element influence determination apparatus, comprising:
an acquirer that acquires request information indicating a first element included in a system, and a second element that is a target of determining whether or not an influence is felt when a change is made to the first element, based on user input;
a system information storage device that stores system information including attribute information indicating attributes of various elements of the system;
a relationship information storage device that stores relationship information indicating relationships providing direct interaction among the elements, in the system; and
an influence determiner that creates a system network model that models the system by virtually connecting the various elements included in the system on the basis of the system information and the relationship information, and determines whether or not an influence is felt by the second element indicated by the received request information when changes are made to the first element indicated by the received request information, based on the system network model created.

6. The inter-element influence determination apparatus according to claim 5, wherein:
the attribute information includes, for each element, target attribute information indicating materials or services supplied to the element and/or materials or services the element supplies to other elements, supplier attribute information indicating elements that are suppliers of materials or services supplied to the element, and suppliee attribute information indicating the other elements that are suppliees of materials or services supplied by the element; and
the influence determiner creates the system network model by causing elements that are suppliers of the materials or services and elements that are suppliees of the materials or services to be connected, based on the attribute information.

7. The inter-element influence determination apparatus according to claim 5, wherein:
the system information storage device further acquires and stores event information indicating an event related to the attribute information of an element; and
the relationship information includes event occurrence time relationship information indicating a relationship providing direct interaction among elements while the event is occurring.

8. The inter-element influence determination apparatus according to claim 5, further comprising a relationship information generator that generates the relationship information from the system information by finding relationships among elements of the system based on rules established in advance.

9. An inter-element influence determination method, comprising:
acquiring request information indicating a first element included in a system, and a second element that is a target of determining whether or not an influence is felt when a change is made to the first element, based on user input;
creating a system network model that models the system by virtually connecting the various elements included in a system on the basis of system information including attribute information indicating attributes of various elements of the system and relationship information indicating relationships providing direct interaction among elements in the system; and
determining whether or not an influence is felt by the second element indicated by the acquired request information when changes are made to the first element indicated by the acquired request information, based on the created system network model.

10. A non-transitory recording medium on which is recorded a program that causes a computer to function as:
acquisition means that acquires request information indicating a first element included in a system, and a second element that is a target of determining whether or not an influence is felt when a change is made to the first element, based on user input;
creation means that creates a system network model that models the system by virtually connecting the various elements included in a system on the basis of system information including attribute information indicating attributes of various elements of the system and relationship information indicating relationships providing direct interaction among elements, in the system; and
influence determination means that determines whether or not an influence is felt by the second element indicated by the acquired request information when changes are made to the first element indicated by the acquired request information, based on the system network model created by the creation means.
